(19) United States
(12) Patent Application Publication
(10) Pub. No.: US 2004/0162838 A1
(43) Pub. Date: Aug. 19, 2004

(54) Hierarchical database apparatus and method of developing hierarchical database

(76) Inventors: Hiroshi Murayama, Yokohama-shi (JP); Yumiko Shimogori, Kawasaki-shi (JP); Noriko Minamino, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/717,561

(22) Filed: Nov. 21, 2003

(30) Foreign Application Priority Data
Nov. 22, 2002 (JP) 2002-339929

(51) Int. Cl. G06F 7/00

(52) U.S. Cl. 707/100

(57) ABSTRACT

A database management apparatus which manages a database having a hierarchical classification structure is described. In the hierarchical classification structure, a lower classification inherits a property of an upper classification that defines a plurality of properties. The apparatus includes a setting unit configured to set a typical property set. The typical property set includes at least one of selective properties each selected from the properties defined in the upper classification. All of the selective properties are inherited by the lower classification. The apparatus also includes a storage which stores the typical property set in association with the hierarchical classification structure.

### CROSS-REFERENCE TO RELATED APPLICATIONS

This application is based upon and claims the benefit of priority from the prior Japanese Patent Application No. 2002-339929, filed Nov. 22, 2002, the entire contents of which are incorporated herein by reference.

### BACKGROUND OF THE INVENTION

1. Field of the Invention

The present invention relates to a hierarchical database having a scheme for inheriting the properties of classifications (classes) and, more particularly, to a database that can set typical properties.

2. Description of the Related Art

A versatile operating system (OS) such as Windows(™) available from Microsoft Corporation, UNIX(™), LINUX(™), and the like adopts a tree representation as a graphic user interface (GUI) that visually presents a tree-like directory structure and file structure to the user and navigates the user to a specific directory or file. Among modes of this tree representation, information (files and the like) contained in an upper node and that contained in a lower node have neither an inheritance relation nor an inclusive or subset relation, and nodes on a tree starting from a root note are merely holders that store information such as files and the like, i.e., containers, which are connected in a tree pattern. Such structure will be specifically referred to as a “hierarchical file structure” in this specification.

On the other hand, databases such as an object-oriented database (OODB) and an object-relational database (ORDB) which has appeared as a partially improved version of a relational database (RDB) have a hierarchical structure. The hierarchical structure has a scheme that allows lower classifications to inherit the properties of upper classifications. Such database is characterized in that properties increase progressively by inheritance in lower classifications. Such scheme that allows lower classifications to inherit the properties of upper classifications is also called “inheritance”, and such technique is described in many references (e.g., “Object-Oriented Concepts, Databases, and Applications, Edited by Won Kim, 1989, ACM Press”). In the technical field associated with object-oriented databases (OODB), classifications in a hierarchy are normally called “classes”. This specification uses “classification” and “class” as terms having nearly the same meanings.

In an object-relational database (ORDB), a table that allows inheritance corresponds to a class. Among tables in a hierarchy, lower tables inherit properties from upper tables. A property to be inherited in ORDB corresponds to header information of each column that forms the upper table, and is inherited by lower tables.

In this specification, both the object-oriented database (OODB) and object-relational database (ORDB) will be generally referred to as a “hierarchical database”. Data which belong to a class of each layer and have an identical property type will be referred to as “instances”, and a set of such “instances” will be referred to as a “population” hereinafter.

Various implementation methods of a population are available. For example, in an ORDB, a population is implemented as one or a plurality of tables per classification. When a population is implemented as a plurality of tables, the whole population is expressed by a set operation and JOIN among tables.

The ISO13584 Parts Library standard (this goes by the name of “PLIB”) is an international standard, which specifies the semantics of an object-oriented representation method associated with products consisting of a plurality of “Parts” or part library data, and its exchange file format, i.e., specifies the terms, representation method, and data format to be used. The contents of Part 42 of the ISO13584 Parts Library standard are common to those of IEC61360-2. This standard is a scheme for classifying products in an object-oriented manner, clarifying a property group that characterizes each individual classification, and exchanging contents corresponding to the classification via files. Therefore, the concept of property inheritance is included in that standard. Also, this standard is formed by quoting “ISO6523 “Structure for Identification of organizations and organization parts”. Especially, this standard can assign globally unique identifiers to properties by exploiting ICDs (International Code Designers) specified by ISO6523.

A database such as an object-oriented database, which has a hierarchical structure in which lower classifications inherit the properties of upper classifications, has a structure in which the properties in the lower classifications increase progressively as they are inherited. For this reason, it is difficult to discriminate (typical) properties which are frequently used in selection by general users and represent classifications from other extrinsic properties or those which are required for exclusive use purposes or user groups. Hence, a manufacturing specification database of industrial products often has several hundred properties.

Therefore, when several ten property types appear upon selection of a product, it is not obvious for the user which of properties he or she should take notice to select an instance, or information associated with which of properties is typically requested. For example, in case of a manufacturing specification database of industrial products, when properties are not categorized, the number of properties is too large to easily recognize the features of individual product instances and to select an instance by narrowing down its range using property values. For this reason, property types are often categorized.

However, in the conventional system, such categories are set independently of classifications (classes) (for example, IEC-61360-2 and ISO13584-42 describe the categories of properties based on ISO-31. Or even when categories are set for respective classifications, they are simply inherited depending on the inheritance mechanism of a database itself having the aforementioned hierarchical structure, and cannot be independently and selectively inherited with respect to the inheritance mechanism.

Therefore, a new concept is required to set typical properties in association with the classifications of a hierarchical database. Furthermore, a database structure that preserves typical properties, a scheme for preserving query conditions for typical properties, and a scheme for presenting an instance that matches such query condition to the user are demanded. However, these structure and schemes fall outside the scope of the ISO13584 standard, IEC61360 standard, and ISO6523, and have not been provided yet.

### BRIEF SUMMARY OF THE INVENTION

The present invention is directed to a database management apparatus and a database management method for setting typical properties in association with the classifications of a hierarchical database, and a method of developing a hierarchical database.

One aspect of the present invention includes a database management apparatus which manages a database having a hierarchical classification structure. In the hierarchical classification structure, a lower classification inherits a property of an upper classification. The upper classification defines a plurality of properties. The apparatus includes a setting unit configured to set a typical property set. The typical property set includes at least one of selective properties each selected from the properties defined in the upper classification. All of the selective properties are inherited by the lower classification. The apparatus also includes a storage which stores the typical property set in association with the hierarchical classification structure.

### BRIEF DESCRIPTION OF THE SEVERAL VIEWS OF THE DRAWING

FIG. 1 is a schematic block diagram showing the arrangement of a hierarchical database apparatus according to an embodiment of the present invention;

FIG. 2 shows the relationship among classifications (classes), properties, typical properties, and query conditions (query condition sets);

FIG. 3 shows a case wherein typical property groups and query conditions (query condition sets) are respectively set in correspondence with a plurality of users;

FIG. 4 is a table showing an example wherein typical properties are associated with e-mail addresses;

FIG. 5 is a view showing an example wherein e-mail addresses are associated with typical property groups;

FIG. 6 shows a matching model of information registrars and information users;

FIG. 7 shows an example of a table that stores typical properties;

FIG. 8 shows an example of query conditions associated with typical property groups that contain inheritance properties for classification class 2;

FIG. 9 is a flowchart showing the setting sequence of a typical property for a class;

FIG. 10 is a flowchart showing the matching sequence between an information user and information supplier;

FIG. 11 shows an example of a GUI of a hierarchical database having one group of typical properties;

FIG. 12 shows an example of a GUI of a hierarchical database having a plurality of groups of typical properties;

FIG. 13 shows a description example of a typical property setting file;

FIG. 14 shows a window display example of a property set for an upper classification class “industrial instrument”;

FIG. 15 shows a window display example of a property set for a lower classification class “flowmeter”; and

FIGS. 16 and 17 show an example of a typical property setting file for FIGS. 14 and 15.

### DETAILED DESCRIPTION OF THE INVENTION

A preferred embodiment of the present invention will be described below with reference to the accompanying drawings.

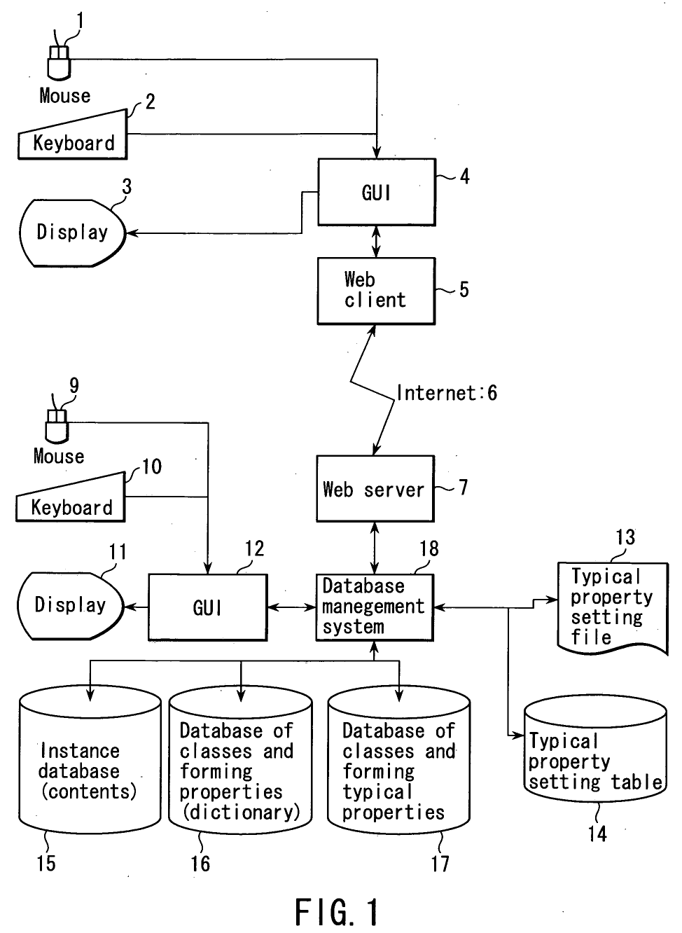

FIG. 1 is a schematic block diagram showing the arrangement of a hierarchical database apparatus according to an embodiment of the present invention. This system is a Web (WWW)-based system via Internet 6, and its building components can be separated into those on the Web client 5 side, and those on the Web server 7 side. The system on the Web server 7 side corresponds to the embodiment of the present invention. Note that the present invention is not limited to such client-server system that requires network communications.

A Web client 5 is built using a versatile computer, which comprises a mouse 1, keyboard 2, display 3, and GUI 4. The Web client 5 outputs data received from a Web server 7 to the display 3 via the GUI 4. Also, the Web client 5 receives data and commands from pointing devices such as the keyboard 2, mouse 1, and the like from the user, and sends them to the Web server 7.

The Web server 7 can be built using a versatile computer, which comprises a mouse 9, keyboard 10, display 11, and GUI 12, as in the Web client 5. Furthermore, the Web server 7 comprises a database 16 which is also called a “dictionary”, and stores classes and properties that form these classes, a database 15 which is also called “contents” and stores a group of property values of individual classes, i.e., instances, and a database 17 which stores typical properties of classes. Also, the Web server 7 comprises a database management system 8 which manages input/output of data to/from these databases 15, 16, and 17, and execution of searches.

The typical property database 17 can be set and developed based on inputs from the keyboard 10. In order to allow easy initial setup of this database 17, an external file 13 used to set typical properties or a typical property setting table 14 can be used alongside the typical property database 17.

The dictionary, i.e., the database 16 which stores classes and properties that form these classes records information about the relationship among classes. That is, when the user selects one class, he or she can recognize its upper class (super class) and lower class(es). The dictionary database 16 records information associated with properties that belong to each individual class. When the user selects one class, he or she can recognize information associated with all properties that belong to that class.

The typical property database 17 records information associated with typical properties that belong to each individual class. When the user selects one class, he or she can recognize all typical property groups which belong to that class and all properties which form each individual property group.

In this embodiment, properties which represent a given classification are arranged into one or a plurality of groups of typical properties. Each layer inherits this group (as well as negative inheritance). Furthermore, each individual layer inherits such group as a “typical property set” that includes typical query condition values for typical properties together as if a kind of class. Hence, the user can add/delete data to/from this typical property set, and can change conditions for each class. When the user selects an element on a GUI corresponding to this group, e.g., a button or the like, a dialog used to input information and a query value associated with properties that belong to one of the typical property sets is displayed, thus facilitating selection of instance data in each classification.

Each typical property set that contains typical properties of a class and their query conditions can contain extrinsic information such as use examples, input example, supplementary explanations, and the like in addition to the query conditions. Of these contents, only query conditions will be referred to as a “query condition set” hereinafter. Note that the concept of such typical property set is different from that of a query primary key or INDEX in a relational database (RDB) and is independent of them. If no layout/display order is designated between properties which belong to a given group, i.e., if they merely belong to a given typical property group, a specific display or inheritance order is not given. Each individual property set is independent, i.e., one property may appear in a plurality of typical property sets.

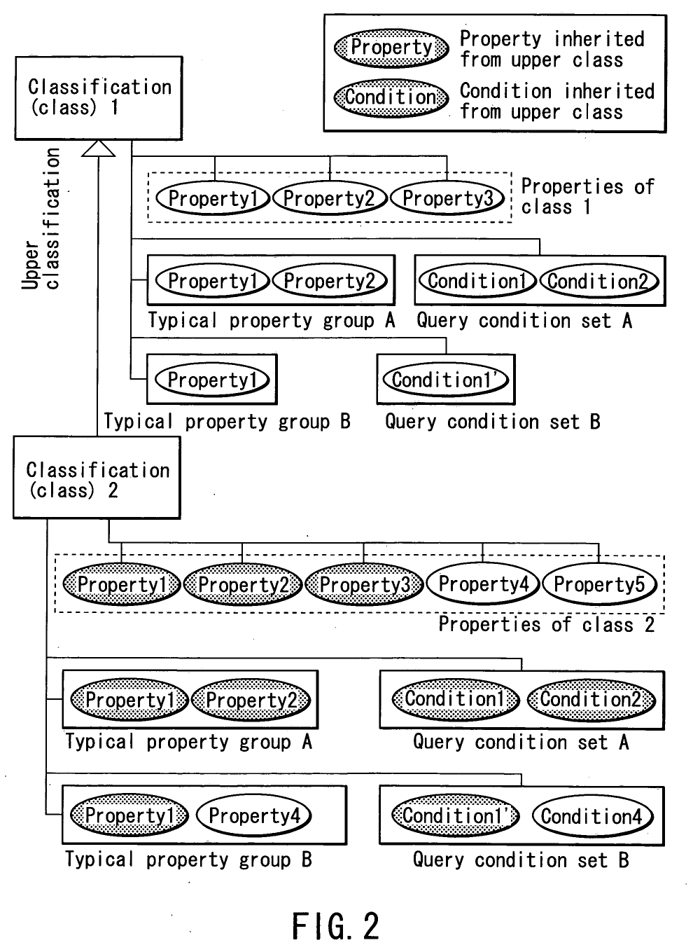

FIG. 2 illustrates a structure which expresses the relationship among classes, properties, typical properties, and query conditions in the hierarchical database of this embodiment, i.e., the relationship among classes, that between classes and properties, that between classes and typical properties, and that between typical properties and query conditions. All classes except for a root class as the top of them can trace upper classes. Each class inherits properties, a typical property group, i.e., a group of one or a plurality of properties, and query conditions corresponding to that typical property group of a given upper class from that upper class. Therefore, in this embodiment, a query condition corresponding to a given typical property group can be considered as one class.

<Inheritance of Query Condition>

This embodiment allows inheritance of not only properties but also query conditions, as described above. That is, as for a typical property used to search for a specific classification, a query condition corresponding to that property value, and an example of the query condition are also typical. Hence, lower classifications can often inherit and use query condition values corresponding to typical property groups of upper classifications. However, in a conventional hierarchical database, such query condition is to be filled by the user, and is not inherited unlike properties. That is, the conventional hierarchical database has no scheme for allowing lower classes to inherit such query conditions as default ones.

Furthermore, the conventional database has no scheme that saves such typical property group, corresponding query conditions, and an identifier of each individual user who sets them or of a group to which such user belongs in association with each other, and presents, to the user, appropriate typical properties or a group of typical properties and query conditions corresponding the identifier of that user or a group to which he or she belongs when that user or an arbitrary user who belongs to the group wants to search for an instance about that classification again. The concept of inheritance of query conditions is different from those of inheritance and initialization of properties of “class” in C++ or Java that represents aggregation or encapsulation of foreign data type variables on a memory, which are normally provided by an object-oriented programming language, since it relates to query conditions with respect to a database.

<Negative Inheritance>

This embodiment has an effect of losing a typical property associated with a newly added lower classification (sub class) by negative inheritance.

A database such as an object-oriented database, which has a hierarchical structure in which lower classifications inherit the properties of upper classifications, has a structure in which the properties in the lower classifications increase progressively as they are inherited. However, in classifications of actual products or lifeforms, along with the advance of technologies or in the course of evolution of lifeforms, features or natures in upper classifications above a given layer may disappear in layers lower than that layer as an origin. Such disappearance cannot be appropriately expressed by the concepts of the conventional object-oriented databases and hierarchical databases.

For example, a conventional home electric vacuum cleaner has a power cable, and a power supply and the cleaner are always connected via the power cable. However, recently, an electronic vacuum cleaner, which has no such power cable for the purpose of improving operability, and drives a motor by converting electric power supplied from a battery into power, is commercially available. Also, a recent home electric iron is of heat accumulation type, which has a power cable between a power supply and its holder, but has no power cable on its main body which actually contacts clothes. These are classified as the developed forms of the electronic vacuum cleaner and iron. However, since the presence of the power cable is indispensable in the conventional electronic vacuum cleaner and iron, a property “power cable” is normally generated in classifications of the electronic vacuum cleaner and iron as upper classifications.

Automobiles require combustion engines independently of their fuels (gasoline, diesel oil, and the like). However, recent ecologically friendly electric vehicles have no combustion engines. At this time, if “combustion engine type” as a property unique to an automobile is removed, and “engine type” is added as a new property to lower classifications (e.g., sedan and the like), problems can be avoided. However, in many databases irrespective of their types, once a property unique to a given classification is defined, instance data are input and stored according to that property. Therefore, deleting properties from classifications afterward often causes serious problems upon database management.

This embodiment allows setups that can import the new property inheritance scheme, i.e., negative inheritance. That is, a negative property, which means disappearance of a property and is incorporated in typical properties in a given classification, has a peculiarity in that the corresponding typical property groups in lower classifications do not inherit the negative property as an actually effective property, or the negative property is not handled as an effective one in these classifications if it is present.

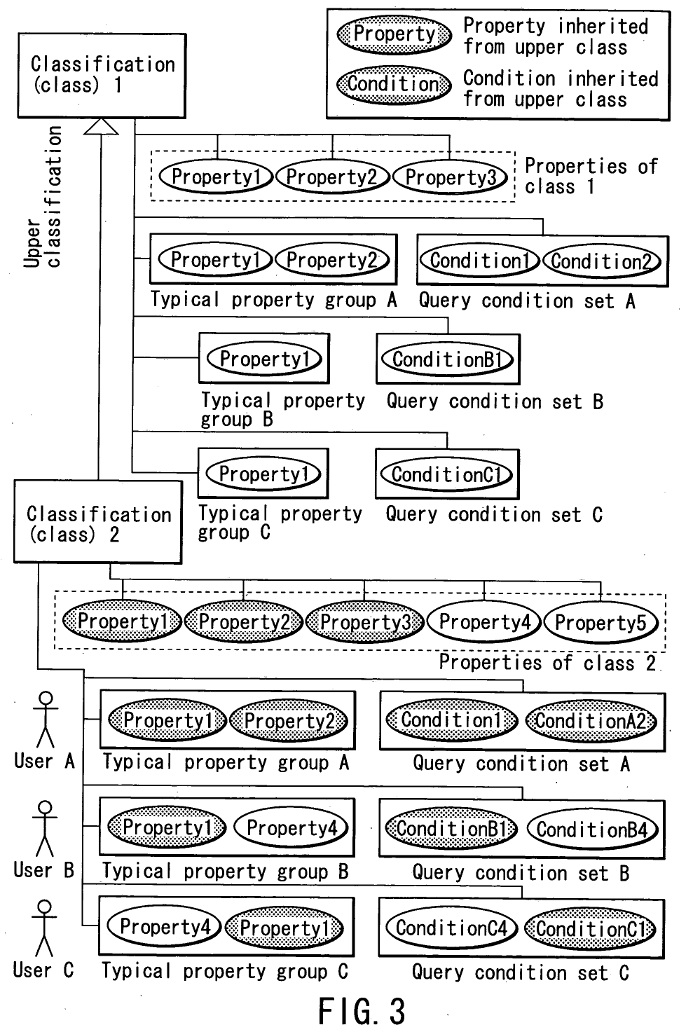

FIG. 3 shows a case wherein typical property groups and query conditions (query condition sets) are respectively set in correspondence with a plurality of users.

In this embodiment, three typical property groups A, B, and C are respectively set in correspondence with users A, B, and C. These typical property groups A, B, and C are inherited from upper class 1. In FIG. 3, class 2 inherits typical properties and query conditions in dot-hatched ovals of those indicating the typical properties and query conditions from upper class 1. The identifier of each user or a group to which that user belongs is associated with this typical property set, and displayable and selectable typical property sets are limited in accordance with the identifier of the user or the group to which that user belongs.

<E-mail Message>

An e-mail or s-mail address is added to information that associates the typical property set and the user or the group to which he or she belongs. When a new instance that matches a query condition described in the typical property set is registered, an e-mail or s-mail message that advises accordingly can be automatically sent to the registered user or all registered users in a given user group using the e-mail or s-mail addresses.

In some cases, the user cannot find any instance that matches a condition that he or she wants upon searching the database, and an instance that satisfies the condition is registered in a class selected as the user's query range or its lower class (sub class). In this embodiment, query conditions are registered for respective users. When a new instance is registered, the existing query conditions of the users are applied to such instance to check if that instance matches the conditions. If the instance matches a given condition, a message that advises accordingly is sent to the registered user, thereby solving the aforementioned problem. Such instances that match the conditions are required by not only human users but also software such as other databases, applications, and the like.

A specific e-mail address may be in a database for the database or an application as the user. When new instance data that satisfies a condition is registered by an information supplier, the instance can be replenished as needed by receiving an e-mail message that advises accordingly.

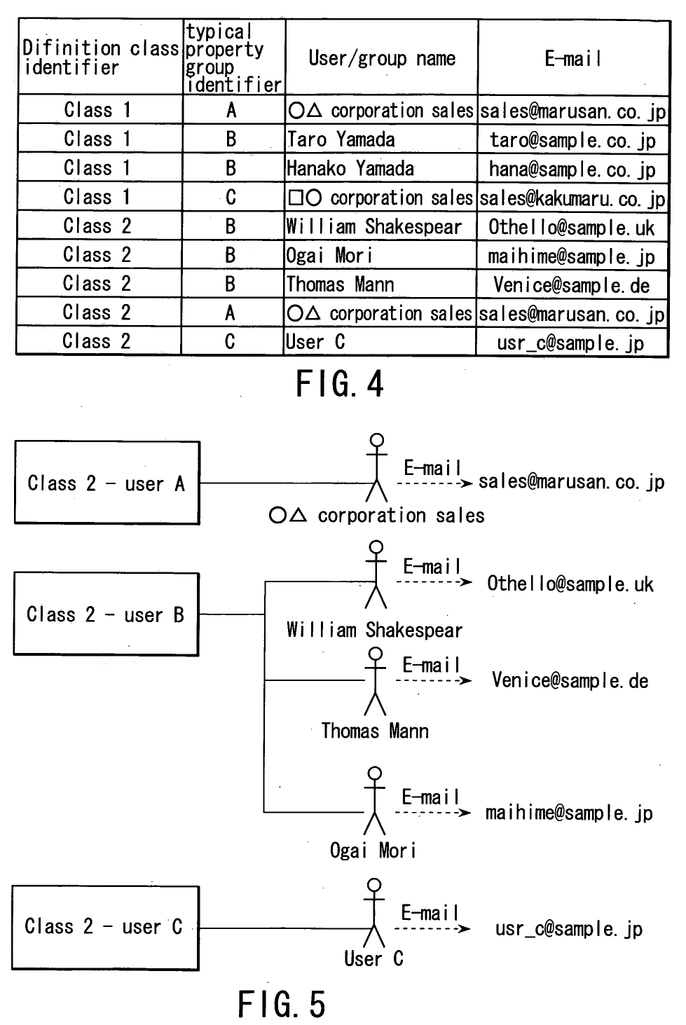

In FIG. 4, the e-mail address of a user group “◯Δ Corporation Sales” is associated with user A for class 2 shown in FIG. 3; those of three imaginary users “William Shakespeare”, “Thomas Mann”, and “Ogai Mori” with B; and that of “user C” with C. FIG. 5 shows the relationship between the e-mail addresses and typical properties.

When a new instance that matches a query condition described in a typical property set is registered, a URI (Universal Resource Identifier) of the instance that matches the query condition is included in an e-mail message to be sent to the user, thereby directly navigating the user who receives the message to a window that displays the instance. Originally, in many existing applications, the URI allows the user to drive a CGI or servlet by only clicking its character string, and to drive a script or program so as to display information on his or her Web browser.

In this embodiment, an e-mail address that can be directly accessed by another database or application set at another Internet address via a program is included as an address of a message to be sent when a new instance that matches a query condition described in a typical property set is registered. Then, an e-mail message is sent to that address, or an e-mail message is sent to an e-mail address that the latter database can indirectly access the contents of the e-mail message, thus automatically informing the database or application of update of instance data that matches the query condition. Furthermore, automatic data update in the latter database or application is implemented.

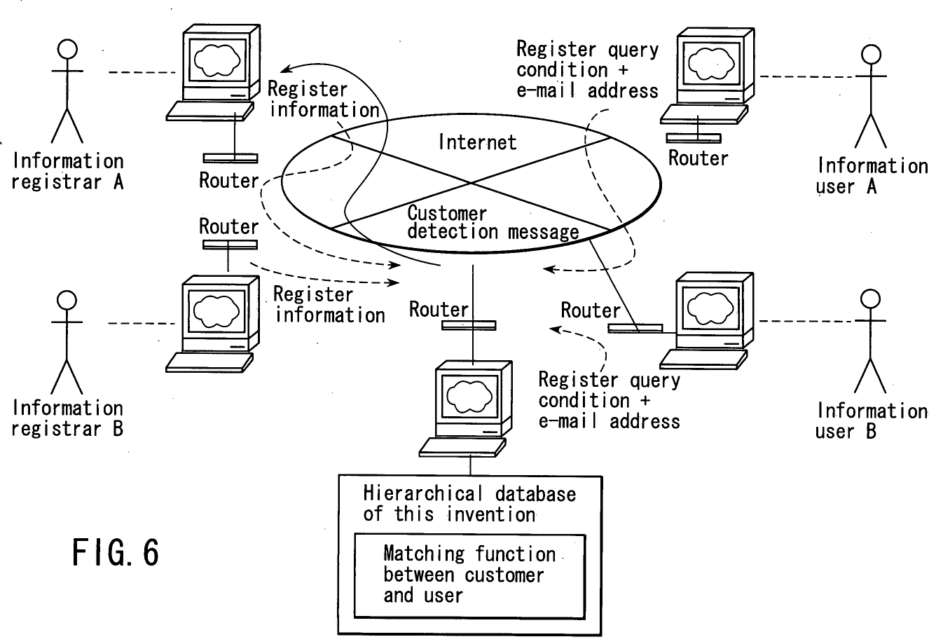

When an information registrar registers new instances in the database 15, and such instances include an instance which match a query condition described in a typical property set, an e-mail message is sent to the information registrar who provided that instance using an e-mail address which is given as one of property values in the instance or is prepared separately in association with the instance (e.g., an e-mail address which is described in a file whose URI is designated by a character string value of a property in the instance), thus matching between the user and information supplier of instance information. FIG. 6 shows a matching model between information registrars and information users. Note that a property itself that describes an e-mail address of the information supplier need not always be contained in a typical property.

In case of the hierarchical database, lower classes inherit properties set by upper classes. Hence, when an upper class sets a property corresponding to “information supplier's e-mail address” as, e.g. a character string type as one of inheritance properties, lower classes can have this property. Therefore, respective instances of lower classes respectively have a character string value of an e-mail address corresponding to this property.

Especially, when a standard code description method called a BSU (Basic Semantic Unit) specified by Part 42 of ISO13584 Parts Library Standard is used as a property identifier corresponding to “information supplier's e-mail address”, this code has a structure that becomes a globally unique code via the ISO6523 International Code Designer (ICD). Hence, one BSU (that is, property BSU or Property_BSU) code is assigned to a property “information supplier's e-mail address”, a database system is programmed to recognize that code as the one used to send an e-mail message, and this dictionary is open to the public as a standard dictionary. When the hierarchical database of this embodiment is used under such circumstance, a matching mechanism between information users and information suppliers can be equally effective for instance data with respect to all global product classification dictionaries, which are created by quoting the definitions in this dictionary.

<List>

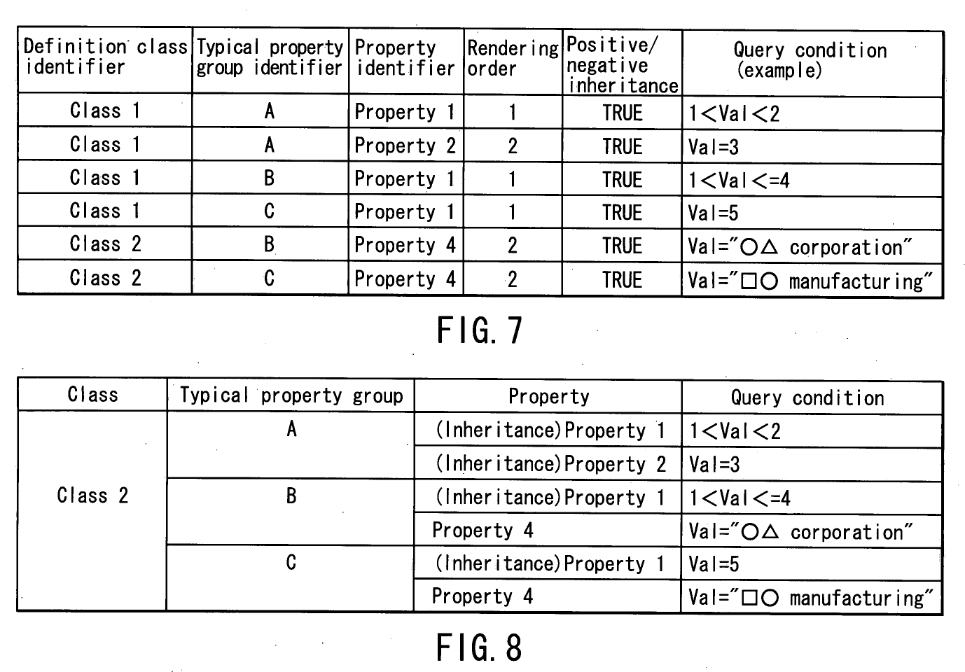

This embodiment prepares one or a plurality of lists, which can be looked up from respective classifications, and each of which can be identified by an identifier (name or code). As elements of each list, the identifiers of properties which belong to a typical property set provided to a given classification, their display or layout order, and their query condition values are described. This list structure corresponds to FIG. 3. As the save format of this list, a table of a relational database shown in, e.g., FIG. 7, may be used in place of a file. Query conditions may or may not be present depending on properties. In query conditions, those which bind a value may be described. FIG. 8 summarizes the contents to be described in the table of FIG. 7 in association with class 2.

As for the display or layout order, when the list is used, the order described in the list may be used as a default display order. As a default state, the order described in the list not used to indicate the display or layout order, and integers or the like may be additionally described in properties to designate the display or layout order. Since the respective rows of the table in the relational database shown in FIG. 7 do not have any specific order determined in advance, integer or character string type fields are independently set in a “rendering order” column to indicate the display or layout order.

As the initial setting method of this typical property set list, the list may be generated with reference to the setting file 13 shown in FIG. 1, or setups corresponding to respective classifications may be loaded from the typical property setting database 14 present on a secondary storage such as a hard disk or the like and typical property sets may be determined for respective classifications.

In this case, the contents of the typical property set list associated with typical properties, which is generated based on setting files of upper classes and is to be inherited by lower classes, are often different from those of setting files for lower classes in practice. In this case, the contents of the typical property set list are temporarily determined using the contents of setting files to be inherited from upper classes. Then, the contents of the typical property set list to be defined in setting files of lower classes are added to the temporarily determined typical property set list. Or when the contents for upper classes are different from those for lower classes, the corresponding contents for upper classes may be overwritten by those for lower classes. Alternatively, the contents of the typical property set list are temporarily determined using the contents of setting files for lower classes, and the contents of the typical property set list for upper classes may be copied for properties which are not described in these setting files. In this case, since a typical property indicating negative inheritance is marked with “FALSE” in a “positive/negative inheritance” column, as shown in, e.g., FIG. 7, it can be skipped from being copied.

With this method, the contents which are inherited by lower classes from upper typical property sets can be overwritten.

The layout and display orders of typical properties are determined in accordance with typical property sets determined in this way. The contents of the typical property set list are finally described and stored in a secondary storage device such as a hard disk or the like or in a file, thus obviating the need for determining the contents of the typical property set list from setting files prepared by the user.

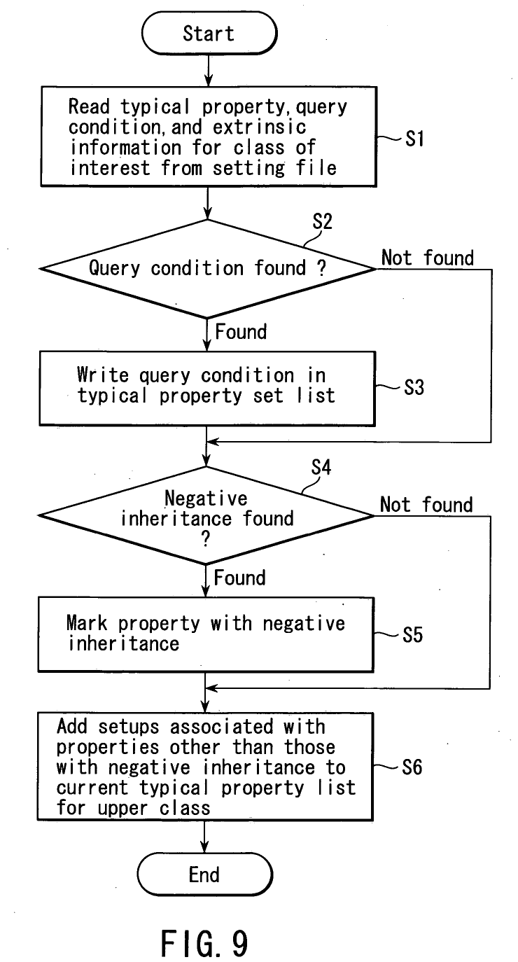

FIG. 9 is a flowchart showing the setting sequence of typical properties for classes using a setting file in which the layout/display order is the order of appearance of property names or identifiers. If the order of appearance is designated by numerical values, these values are read and sorted to the order of appearance in a general process. In step S1, typical properties, query conditions, and extrinsic information of a class of interest are read from a setting file. It is checked in step S2 if query conditions are found. If query conditions are found, they are written in a typical property list (typical property set list) in step S3. It is checked in step S4 if negative inheritance is found. If negative inheritance is found, a property having a negative property is marked in step S5. In step S6, setups associated with properties other than those with negative inheritance are appended to the current typical property list.

<Matching>

As described above, when new instance data that satisfies a condition is registered by an information supplier, an e-mail message that advises accordingly is sent to not only the registrar of the query condition but also to recognized e-mail addresses of information registrars described as properties or their related information in the instance, thus allowing matching between users and providers of information.

When an e-mail address is recognized as a property, and a standard code method that complies with ISO13584 is used for a dictionary of the hierarchical database, 4-digit issuance group codes called ICD used to uniquely identify issuance organizations of individual information code systems on the basis of ISO6523 modify company/group codes in individual information code systems. Furthermore, these company/group codes modify individual class codes and property codes which are effective in each company/group. Hence, a class and properties which belong to that class in ISO standards can be uniquely identified.

ISO13584 has a scheme for quoting (to be referred to as importing hereinafter) some or all classification systems prepared by other groups and companies, i.e., dictionaries into another dictionary when they are used. Lower classifications inherit properties imported by upper classifications in the dictionary.

In this embodiment, if an identifier (property BSU) of a property used as an e-mail address of an information registrar, which is defined by arbitrary standard dictionary A, is temporarily set and is recognized by the system, even when dictionary B that describes another classification system is used, dictionary B can import a property that describes the e-mail address of dictionary A in an upper class. As a result, a property that describes an e-mail address can be specified using a standard code of A without using any nonce, special, implementation-dependent property identification method and without being troubled by superficial differences of property names.

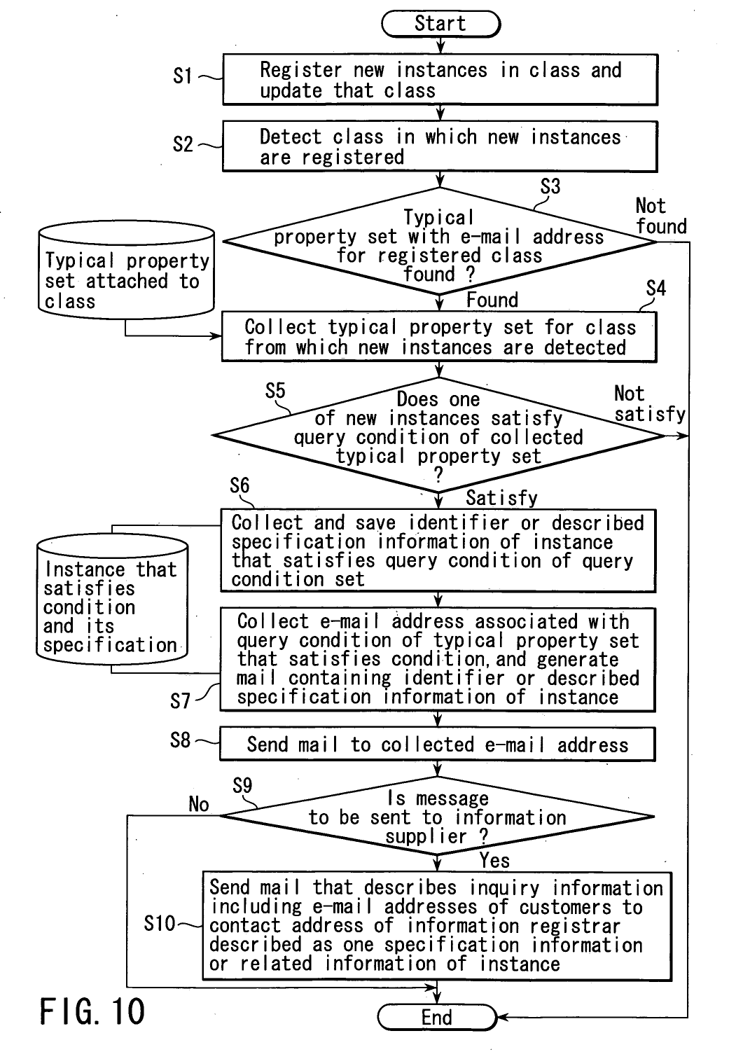

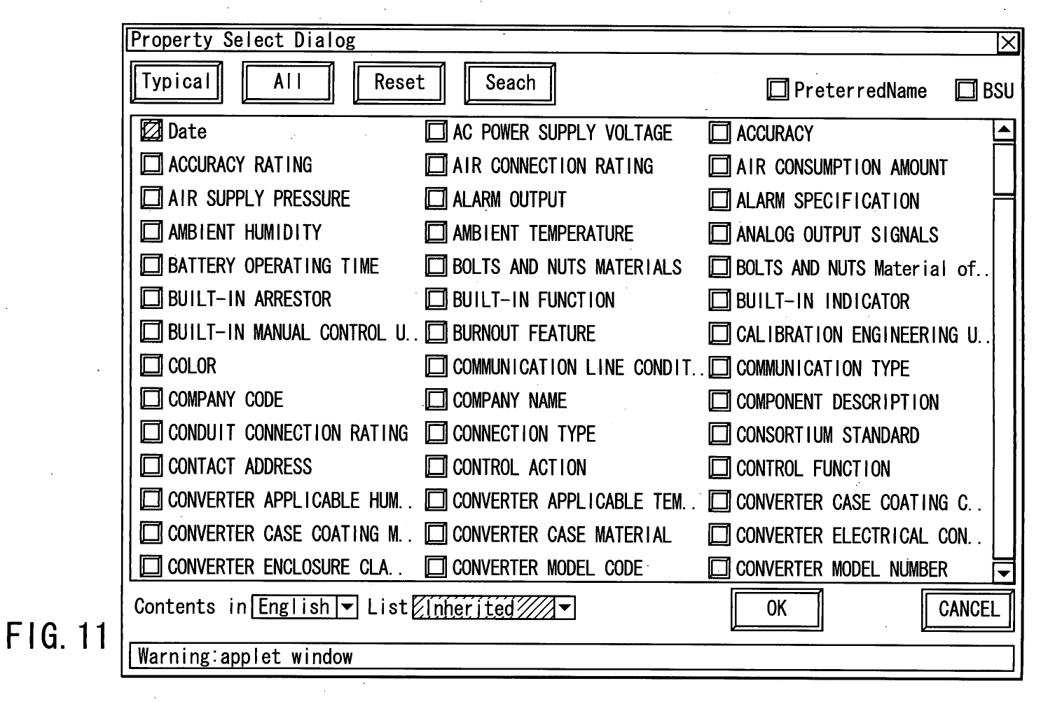

FIG. 10 is a flowchart showing the matching sequence between the information user and information supplier by informing the user of information of an instance that matches a condition. In this sequence, new instances are registered in a class to update that class (step S1). The class in which the new instances are registered is detected and specified (step S2). It is then checked if the registered class includes a typical property set associated with an e-mail address (step S3). If no such typical property set is found, since there is no address to which a registration message of a new instance is sent, the process ends. If it is determined in step S3 that a typical property set associated with an e-mail address is found, a typical property set for the class from which the new instances are detected is collected (step S4). It is checked if one of the new instances satisfies query conditions of the collected typical property set (step S5). If none of query conditions are satisfied, the process ends. If one of the new instances satisfies query conditions, an identifier of the instance that satisfies the query condition, which is specified in a query condition set or specification information described in that instance is collected and saved (step S6). Then, e-mail addresses associated with the query conditions of the typical property set that satisfies the condition are collected, and an e-mail message which contains the instance identifier or specification information described in that instance as contents is generated (step S7). In step S8, the generated e-mail message is sent (transmitted) to the collected e-mail addresses. If this message is also sent to an information supplier (step S9), an e-mail message which describes inquiry information including e-mail addresses of customers (potential customers) to the address of the information supplier which is set in advance as at least a part of the specification information of the instance or its related information is sent.

FIG. 11 shows an example of a GUI of a hierarchical database having one group of typical properties. That is, one typical property set is displayed on the dialog in association with a classification. When the user clicks a “TYPICAL” button in an upper portion of FIG. 11 using a mouse, he or she can simultaneously select all typical properties in this class. FIG. 11 shows properties for a flowmeter, which include more than one hundred properties. Hence, it is difficult for the user to determine typical properties among them. However, with the “TYPICAL” button, the user can automatically select typical properties, thus reducing the load on the user's operation.

Below the “TYPICAL” button, individual property names and their select buttons are displayed. It is preferable to identifiably display square buttons of typical properties, which are set in this class, using a different display color from other properties.

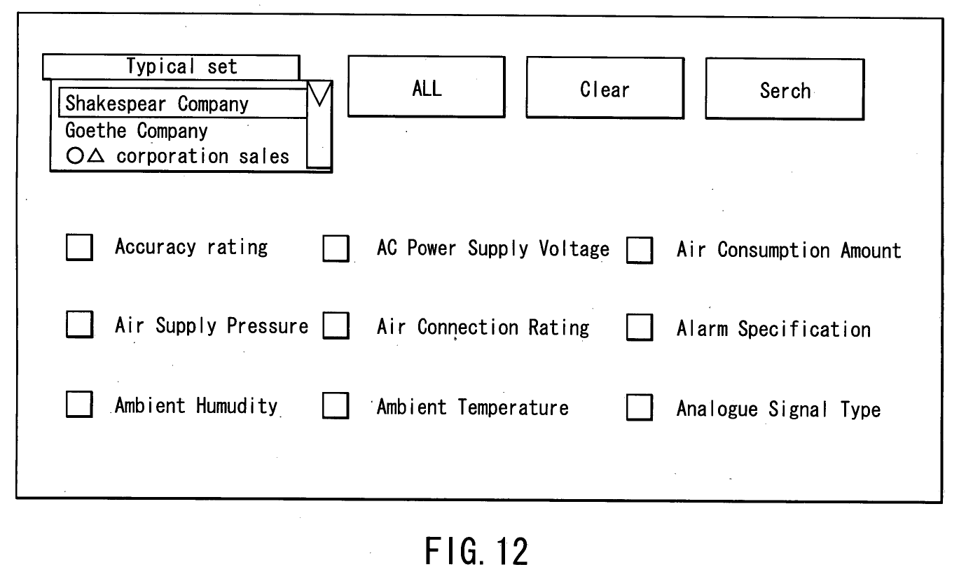

FIG. 12 shows an example of a GUI of a hierarchical database having a plurality of typical property groups. In FIG. 12, three typical property groups are provided.

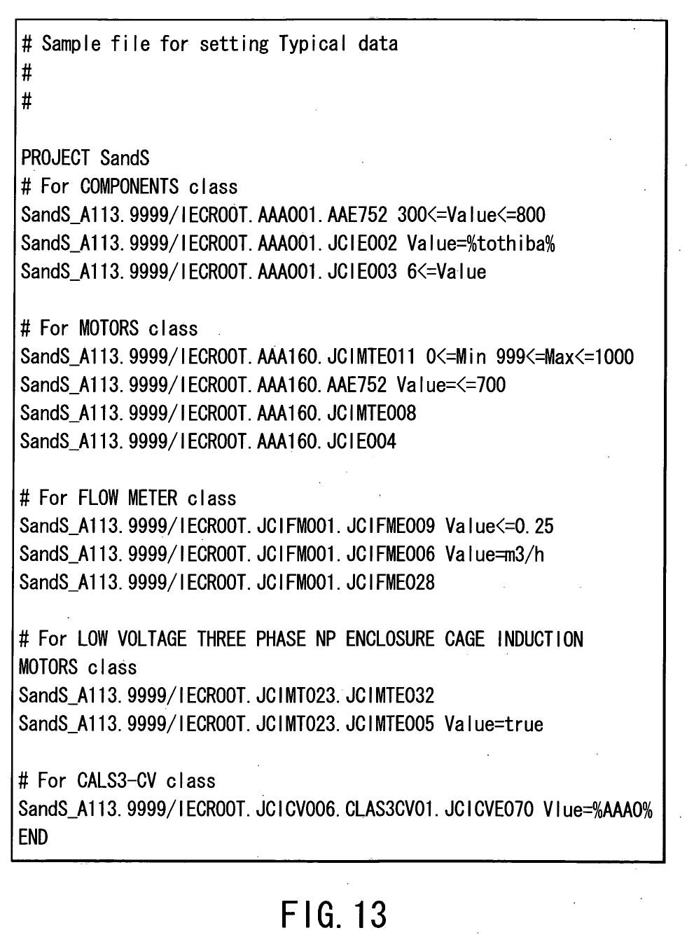

FIG. 13 shows a description example of a typical property setting file. FIG. 13 corresponds to a case wherein the database has one typical property group. This typical property setting file describes all classifications and properties using globally unique identifiers (Supplier_BSU) Class BSU) for identification classifications of information suppliers and identifiers (Property BSU) for properties, whose format is specified by ISO13584 (and by ISO6523 for uniqueness). For example, FIG. 13 describes:

SandS_All3.9999/IECROOT.AAA001.AAE752 300<=Value<=800;

SandS_All3.9999/IECROOT.AAA001.JCIE002 Value=%tasuba%; and

SandS_All3.9999/IECROOT.AAA001.JCIE003 6<=Value

Of these descriptions, SandS_All3.9999/IECROOT is an identifier that represents an information supplier, AAA001 is an identifier of a class, and AAE752, JCIE002, and JCIE003 are identifiers of three different properties of classification AAA001.

Also, “300<=Value<=800” is a designation example of a query condition which designates a range for numerical value type property AAE752. Likewise, “Value=%tasuba%” is a query condition for character string type property JCIE002, and means a character string containing “tasuba” as a value. On the other hand, “6<=Value” is a designation example of a query condition, which is designated with one limit of the range, i.e., which is used to search for a value for numerical value type property JCIE003 is equal to or larger than 6.

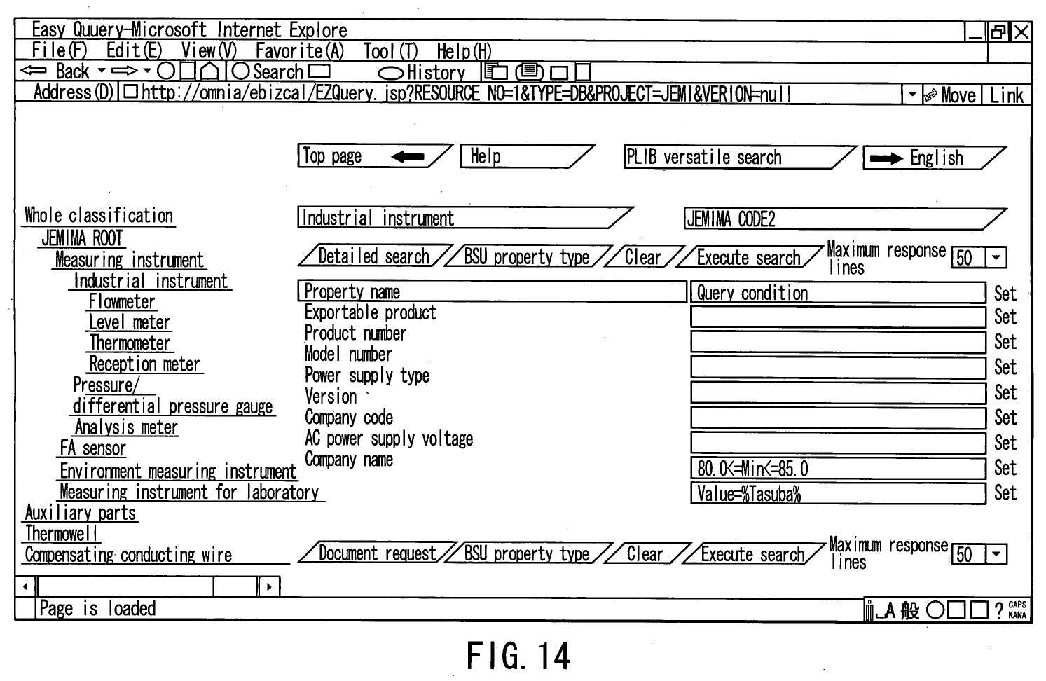

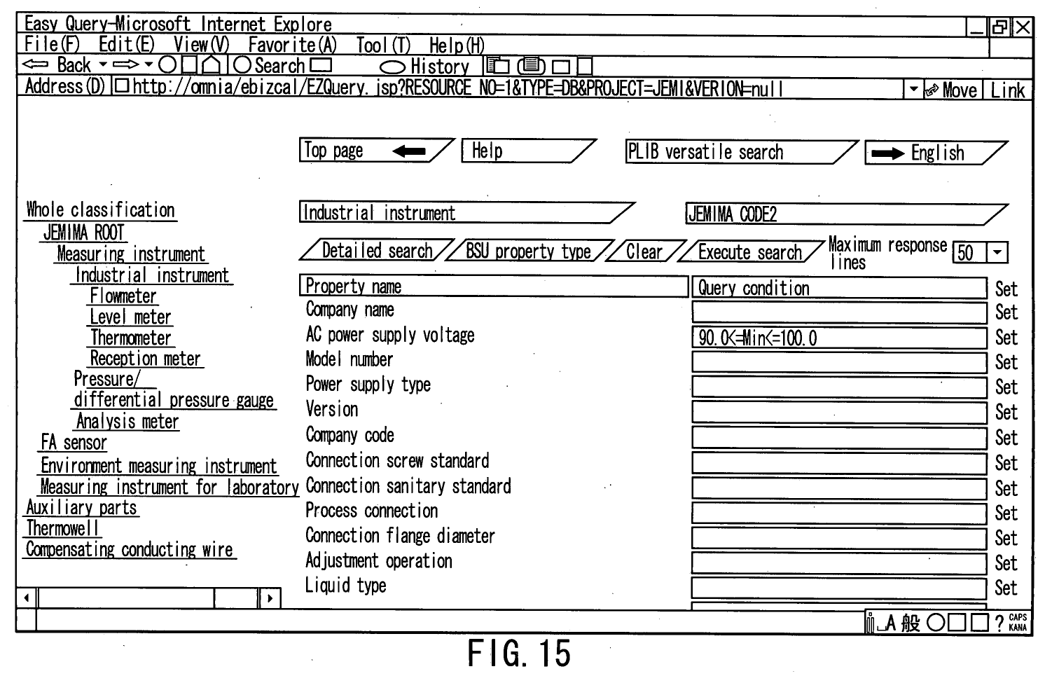

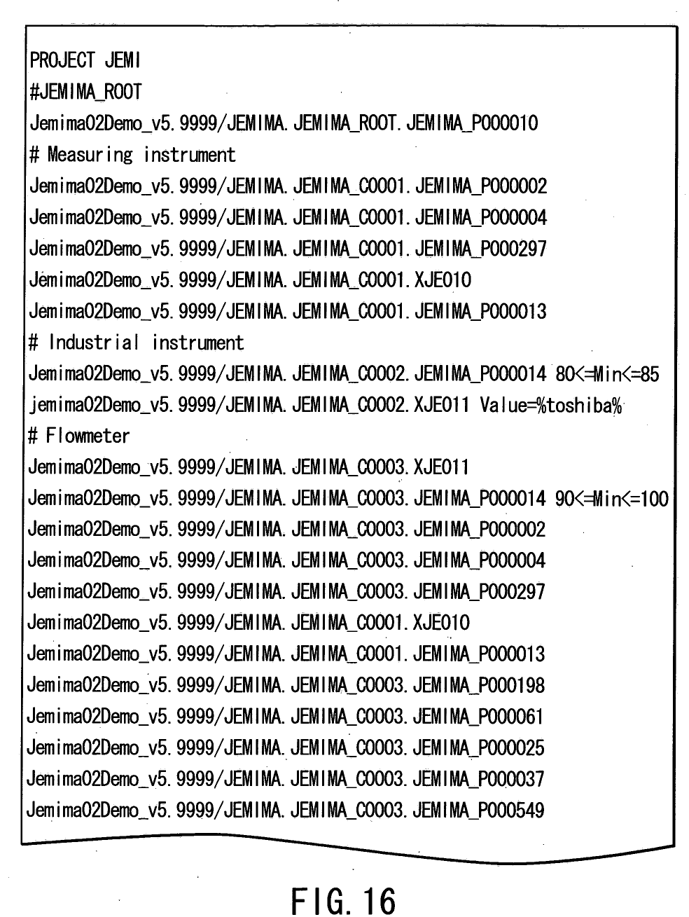

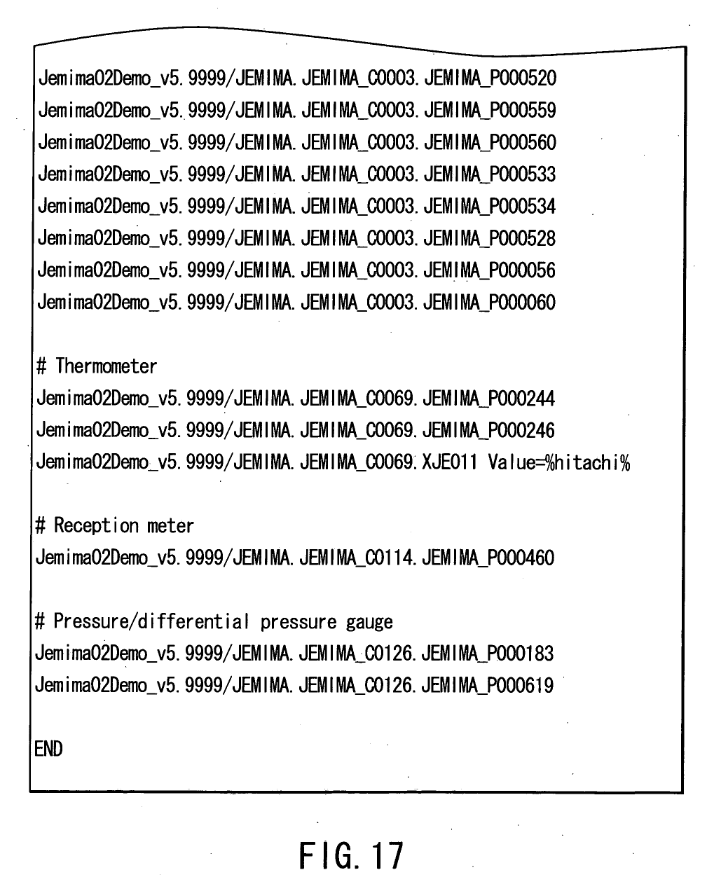

FIGS. 14 and 15 show different GUI examples when only one typical property group is provided. FIG. 14 shows the contents of a property set for “industrial instrument”, i.e., typical properties and query conditions. FIG. 15 shows the contents of a typical property group (property set) for “flowmeter” as a class immediately below “industrial instrument”. FIG. 16 shows an example of setting files for these two classes.

As indicated by italic letters in the list of FIG. 15, in “industrial instrument”, “AC power supply voltage” (property BSU=JEMIMA_P000014) and “company name” (property BSU=XJE011) are defined as typical properties. For “AC power supply voltage”, “80<=MIN value<=85” is set as a query condition. As for “company name”, “Tasuba” is designated using a character string. Also, this description is given to only a new typical property provided in this class. For this reason, the rendering order of “AC power supply voltage” (property BSU=JEMIMA_P000014) and “company name” (property BSU=XJE011) is described so that they are added to the end of all typical properties inherited from “measuring instrument” as an upper class of “industrial instrument”. However, in “flowmeter” as a lower class of “industrial instrument”, the rendering order is given to all properties inherited from “industrial instrument”, and designation of the query condition of “company name” is excluded. In addition, for “AC power supply voltage”, “90<=MIN value<=100” is re-set as a new query condition.

As can be seen from re-confirmation of the rendering order (positions) and query conditions of typical properties displayed in FIGS. 14 and 15, the contents of the setting file are correctly set in typical properties and query conditions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A database management apparatus which manages a database having a hierarchical classification structure in which a lower classification inherits a property of an upper classification that defines a plurality of properties, comprising:
a setting unit configured to set a typical property set including at least one of selective properties, each of the selective properties being selected from the properties defined in the present classification, or an upper classification, and all of the selective properties being inherited by the lower classification; and
a storage which stores the typical property set in association with the hierarchical classification structure.

2. A database management apparatus according to claim 1, wherein the typical property set is independent of another typical property set, and an identical property may belong to both of the typical property set and the another typical property set.

3. A database management apparatus according to claim 1, wherein the setting unit further sets extrinsic information that contains a query condition for each property in the typical property set.

4. A database management apparatus according to claim 1, wherein the setting unit further sets negative inheritance in one of the properties in the typical property set so that the one of the properties fails to be inherited by the lower classification.

5. A database management apparatus according to claim 1, further comprising a display having a screen on which the properties in the typical property set are displayed in a display order inherited by the lower classification together with the typical property set.

6. A database management apparatus according to claim 5, wherein the display order is allowed to be re-ordered by the setting unit of lower classification.

7. A database management apparatus according to claim 1, which further comprises a registry to resister a first user and a second user, and wherein said storage stores a first typical property set to be used by the first user and stores a second typical property set to be used by the second user.

8. A database management apparatus according to claim 7, wherein the registry registers a network address of the first user which a message indicative of registration of a new instance which satisfies a condition is informed of.

9. A database management apparatus according to claim 8, wherein the registry registers the network address of the first user further informed of a URI of the new instance.

10. A database management apparatus according to claim 8, wherein the new instance is transmitted to the first user in response to a request based on the information of registration of the new instance.

11. A database management method of managing a database having a hierarchical classification structure in which a lower classification inherits a property of an upper classification defining a plurality of properties, the method comprising:
setting a typical property set including at least one of selective properties, each of the selective properties being selected from the properties defined in the present classification, or an upper classification, and all of the selective properties being inherited by the lower classification; and
storing the typical property set in association with the hierarchical classification structure.

12. A database management method according to claim 11, wherein said typical property set is independent of another typical property set, and an identical property may belong to both of the typical property sets.

13. A database management method according to claim 11, further comprising:
setting extrinsic information that contains a query condition for each property in the typical property set.

14. A database management method according to claim 11, further comprising:
setting negative inheritance in one of the properties in the typical property set so that the one of the properties fails to be inherited by the lower classification.

15. A database management method according to claim 11, further comprising:
displaying the properties in the typical property set on a screen in a display order, the display order being inherited by the lower classification together with the typical property set.

16. A database management method according to claim 15, wherein the display order is allowed to be re-ordered, using the setting unit of lower classification.

17. A database management method according to claim 11, further comprising:
registering a first user and registering a second user; and
storing a first typical property set to be used by the first user and storing a second typical property set to be used by the second user.

18. A database management method according to claim 17, further comprising:
registering a network address of the first user; and
informing a message indicative of registration of a new instance which satisfies a condition to the first user according to the network address.

19. A database management method according to claim 18, further comprising:
informing the first user of a URI of the new instance.

20. A database management method according to claim 18, further comprising:
transmitting the new instance to the first user in response to a request based on the information of registration of the new instance.
